(19) United States
(12) Patent Application Publication
(10) Pub. No.: US 2002/0197500 A1
(43) Pub. Date: Dec. 26, 2002

(54) Metal powder

(76) Inventors: Ulf Holmqvist, Bethlehem, PA (US); Hans Hallen, Waterloo (BE)

Correspondence Address: Benton S. Duffett, Jr., BURNS, DOANE, SWECKER & MATHIS, L.L.P., P.O. Box 1404, Alexandria, VA, 22313-1404, US

(21) Appl. No.: 09/900,982

(22) Filed: Jul. 10, 2001

(30) Foreign Application Priority Data
May 18, 2001 (SE) 0101776-3

(51) Int. Cl. B32B 15/02

(52) U.S. Cl. 428/570; 428/653; 428/937

(57) ABSTRACT

The invention concerns the use of a diffusion alloy metal powder for thermal coating of substrates. The powder comprises a pre-alloyed iron base powder particles having molybdenum particles diffusion alloyed to the particles of the base powder.

### FIELD OF THE INVENTION

The present invention concerns thermal spray powders, their production and use. Specifically the invention concerns the spray powders for thermal coating of aluminium substrates.

### BACKGROUND OF THE INVENTION

Different methods for producing coatings on aluminium substrates are previously known. These methods are used in eg aluminium engine block having cylinder liners which are formed by thermal spraying.

U.S. Pat. No. 2,588,422 discloses an aluminum engine block having cylinder liners which are formed by thermal spraying. These liners are built up in two layers on the untreated surface of the engine block, the top layer being a hard slide layer such as steel about 1 mm in thickness and the lower layer being a molybdenous interlayer about 50 microns in thickness. The interlayer, containing at least 60% molybdenum, does not constitute a slide layer, but is necessary in order to bind the hard slide layer to the aluminum block. Preferably, the interlayer is made up of pure molybdenum. The slide layer is a layer of hard metal, as for example carbon steel, bronze or stainless steel, in which the steel may be an alloy containing nickel, chromium, vanadium or molybdenum for example. In principle, this two-layer structure provides a good slide layer, but the cost of the double coating is substantial.

In recent thermal spraying methods the thermal spray powders are made up by a mixture of powdered steel with powdered modybdenum such as described in the US Pat. No. 6,095,107. The risk of segregation due to differences in properties between the base steel powder and the powder of crushed molybdenum is however a problem which may result in non-uniform coatings. Another disadvantage is that comparatively large amounts of molybdenum are required due to the segregation effect.

### OBJECTS OF THE INVENTION

A main object of the present invention is to provide an inexpensive metal powder for thermal coating of substrates, especially for aluminium.

Another object is to provide a powder which does not segregate and wherein the amount of expensive molybdenum alloying metal can be reduced in comparison with currently used methods.

A further object is to provide a thermal powder, which has high deposition efficiency and gives excellent coating quality.

Another object is to provide a thermal powder giving coatings of suitable porosity and oxide content and wherein the pores are predominantly closed, isolated and have an advantageous range of pore-diameters.

### SUMMARY OF THE INVENTION

These objects are obtained by a metal powder comprising a pre-alloyed iron base powder having particles of molybdenum, such as reduced molybdenum trioxide, diffusion alloyed to the particles of the base powder.

### DETAILED DESCRIPTION OF THE INVENTION

The type and particle size of the iron base powder is selected in view of the desired properties of the final coating and the substrate. The base powders are preferably pre-alloyed with elements desired in the coating. Also a minor part of the molybdenum content may be included in the pre-alloyed powder. Other elements which may be included in the pre-alloyed base powder are C, Si, Mn, Cr, V and W. The pre-alloyed powder may be prepared by atomisation with water or gas. The particle sizes of the base powder are below 500 μm preferably between 25 and 210 μm for PTA and less than 90 μm, preferably less than 65 μm for HVOF or plasma spraying.

According to the present invention the base powder and the alloying powder, i.e. the source of the alloying element, which is preferably molybdenum trioxide, are mixed according the prescribed formulation and the mixture is heated to a temperature below the melting point of the obtained mixture. The temperature should be sufficiently high to ensure adequate diffusion of the alloying element into the iron base powder in order to form a partially or diffusion alloyed powder. On the other hand the temperature should be lower than the temperature required for complete pre-alloying. Usually the temperature is between 700° and 1000° C., preferably between 750° and 900° C., and the reduction is performed in a reducing atmosphere, e.g. hydrogen, for a period of 30 minutes to 2 hours for reduction of the molybdenum trioxide, which is a preferred molybdenum source. As an alternative molybdenum source metallic molybdenum may be used.

The particle size of the final thermal spray powder is essentially the same as that of the pre-alloyed base powder as the molybdenum particles which are obtained when the molybdenum trioxide is reduced are very small in comparison with the particles of the base powder. The amount of the Mo which is diffusion alloyed to the base powder should be at least 2% by weight of the total powder composition. Preferably the amount of Mo should be between 2 and 15 and most preferably between 3 and 10% by weight.

The different methods for applying the diffusion alloyed powders on the metal base substrate are spray or weld cladding process, such as flame spray, HVO and plasma spray or PTA.

The invention is further illustrated by, but should not be limited to, the following preparation and example.

### EXAMPLE

For the experiment on the new material for thermal coating based on water atomised Fe based (Fe-3Cr-0,5Mo) +5% Mo.

Used base materials and chemical analysis:

Water atomised iron powder (Fe-3Cr-0,5Mo)-71 μm Molybdenum trioxide MoO₃ (Average particle size 3-7 μm)

| Chemical analysis | | Sieve Analysis | |
|---|---|---|---|
| (Fe-3Cr-0,5 Mo) | | (Fe-3Cr-0,5 Mo) | |
| | % | μm | % |
| 0-tot | 1.22 | 71-106 | 0,1 |
| C | 0.48 | 63-71 | 0,8 |
| Fe | Base | 53-63 | 4,7 |
| Ni | 0.05 | 45-53 | 23,4 |
| Mo | 0.52 | 36-45 | 23,1 |
| Mn | 0.10 | 20-36 | 33,3 |
| S | 0.01 | -20 | 14,6 |
| P | 0.01 | | |
| Cr | 2.95 | | |
| Si | <0.01 | | |

Procedure

92,46% of the water atomised (Fe-3Cr-0,5Mo powder) and 7,54% of MoO₃ were mixed together in a Lödige mixer and the annealing was carried out as follows:

Temperature: 820° C.

Time: 60 min

Atmosphere: Reduced atmosphere (type H₂,N₂, CO₂ and mixes of these gases)

After annealing the powder cake was crushed and sieved to a particle size below 75 μm.

Sieve analysis and chemical composition (powder mix after annealing)

| Chemical analysis | | Sieve Analysis | |
|---|---|---|---|
| (Fe-3Cr-0,5 Mo) | | (Fe-3Cr-0,5 Mo) | |
| | % | μm | % |
| 0-tot | 1.5 | 71-106 | 0,1 |
| C | 0.60 | 63-71 | 1,4 |
| Fe | Base | 53-63 | 6,5 |
| Ni | 0.05 | 45-53 | 34,1 |
| Mo | 5.57 | 36-45 | 20,4 |
| Mn | 0.10 | 20-36 | 30,8 |
| S | 0.01 | -20 | 6,7 |
| P | 0.01 | | |
| Cr | 2.75 | | |
| Si | <0.1 | | |

The obtained powder was used in a plasma spraying process for coating an Al base substrate. An unexpectedly homogenous and excellent coating was obtained with a minimum amount of Mo.

1. Metal powder for thermal coating of substrates said powder essentially consisting of pre-alloyed iron base powder particles having molybdenum particles diffusion alloyed to the base powder particles.

2. Powder according to claim 1 wherein the molybdenum particles originate from reduced molybdenum trioxide.

3. Powder according to claim 1 or 2 wherein the amount of molybdenum diffusion alloyed to the particles of the base powder is above 2, preferably above 3% by weight of the metal powder.

4. Powder according to any one of the preceding claims wherein the amount of molybdenum diffusion alloyed to the particles of the base powder is between 2 and 15, preferably between 3 and 10% by weight of the metal powder.

5. Powder according to any one of the preceding claims, wherein the pre-alloyed base powder is a gas-atomised powder.

6. Powder according to any one of the preceding claims, wherein the pre-alloyed base powder is a water-atomised powder.

7. Powder according to any one of the preceding claims wherein the pre-alloyed base powder includes at least one of the elements selected from the group consisting of carbon, silicon, manganese, chromium, molybdenum, vanadium and tungsten.

8. Powder according to any one of the preceding claims having a particle size below 500 μm, preferably between 25 and 210 μm.

9. Powder according to any one of the preceding claims having a particle size below 90 μm, preferably between 65 μm.

10. Powder according to any one of the preceding claims for thermal coating of aluminium substrates.
